(19) United States
(12) Patent Application Publication
(10) Pub. No.: US 2004/0247348 A1
(43) Pub. Date: Dec. 9, 2004

(54) Wet color image forming apparatus and method of forming image using the same

(76) Inventors: Wan-Ha Kim, Suwon-si (KR); Jin-Geun Kwak, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/835,004

(22) Filed: Apr. 30, 2004

(30) Foreign Application Priority Data
Jun. 4, 2003 (KR) 2003-35901

(51) Int. Cl. G03G 15/01

(52) U.S. Cl. 399/302

(57) ABSTRACT

A wet color image forming apparatus and method of using the same is provided. The wet color image forming apparatus includes a transfer belt, which is formed of a plurality of layers including a surface layer contacting a sheet of paper. A hardness of the surface layer is reduced by removing carbon from a material constituting the surface layer. The apparatus also includes a transfer roller which applies pressure to the transfer belt to transfer the color image formed on the transfer belt onto the sheet of paper.

### BACKGROUND OF THE INVENTION

This application claims priority from Korean Patent Application No.2003-35901, filed on Jun. 4, 2003, in the Korean Intellectual Property Office, the disclosure of which is incorporated herein by reference in its entirety.

### FIELD OF THE INVENTION

The present invention relates to a wet color image forming apparatus. More particularly, the present invention relates to a wet color image forming apparatus utilizing an electrostatic pressure transfer method, to improve a transfer efficiency of an image from a transfer belt onto a sheet of paper, and a method of forming an image using the same.

### DESCRIPTION OF THE RELATED ART

In a wet color image forming apparatus using a liquid developing agent, a transfer efficiency from a transfer belt onto a sheet of paper is higher than the transfer efficiency of a dry color image forming apparatus using toner, and as a result, a higher quality image can be obtained.

FIG. 1 shows an example of a conventional wet color image forming apparatus. Referring to FIG. 1, the conventional wet color image forming apparatus includes a photosensitive body portion P1, a developing unit portion P2, and a transfer portion P3. The conventional wet color image forming apparatus also includes a paper feeding and exhaust unit and a developing cartridge (not shown) placed below the developing unit portion P2, for supplying a developing agent to the developing unit portion P2.

The photosensitive body portion P1 includes first through fourth photosensitive bodies 40, 42, 44, and 46, which are spaced a predetermined gap from one another. The first through fourth photosensitive bodies 40, 42, 44, and 46 are photosensitive bodies on which electrostatic latent images corresponding to color images forming an image are formed. Each photosensitive body corresponds to an individual component color of the color image. In a typical example, one photosensitive body is a black (K) photosensitive body on which an electrostatic latent image corresponding to a black image is formed. Typically, the other photosensitive bodies correspond to cyan (C), magenta (M), and yellow (Y).

Reference numerals 50, 52, 54, and 56 denote first through fourth cleaning blades in contact with the first through fourth photosensitive bodies 40, 42, 44, and 46, for cleaning the first through fourth photosensitive bodies 40, 42, 44, and 46. Additional elements provided around the first through fourth photosensitive bodies 40, 42, 44, and 46 (not shown) include an eraser for neutralizing a charging state of each of the photosensitive bodies 40, 42, 44, and 46 after a developed electrostatic latent image is transferred, a charger for charging the surface of the neutralized photosensitive body before the electrostatic latent image is formed, and a light scanning unit (LSU) for forming an electrostatic latent image by radiating light on the surface of the charged photosensitive body.

The developing unit portion P2 is placed below the photosensitive body portion P1 to correspond to the first through fourth photosensitive bodies 40, 42, 44, and 46 and includes first through fourth developing units 60, 62, 64, and 66 for supplying a color developing agent, such as ink, needed in developing the electrostatic latent image formed on each of the photosensitive bodies 40, 42, 44, and 46. Reference numerals 60a, 62a, 64a, and 66a denote first through fourth developing rollers for supplying a color developing agent to the first through fourth photosensitive bodies 40, 42, 44, and 46 through contact with each of the first through fourth photosensitive bodies 40, 42, 44, and 46.

The transfer portion P3 includes a transfer belt 70. Developed resultant images from each of the first through fourth photosensitive bodies 40, 42, 44, and 46 are precisely superimposed onto the transfer belt 70 in a predetermined position and the color image is then transferred.

The transfer belt 70 is formed of polyimide and has a Shore hardness (Shore A) greater than or equal to 70 degrees. Rollers 72, 74, 78, 80, 82, and 84 are provided inside the transfer belt 70, and another roller 76 is installed outside the transfer belt 70 while being opposite to and in contact with the roller 72 where the transfer belt 70 is placed between the roller 76 and the roller 72.

The rollers 72, 74, 78, 80, 82, and 84 maintain the transfer belt 70 in a given shape suitable for transfer. The roller 76 is a paper transfer roller for transferring a color image existing on the transfer belt 70 onto a sheet of paper 90 and is grounded.

The roller 76 preferably has a Shore hardness (Shore A) of about 30 degrees and has some cushion. The roller 72 is a paper transfer backup roller for supporting the roller 76 and is formed of a rubber material preferably having a Shore hardness (Shore A) of about 50 degrees.

When a transfer operation starts, a voltage needed in generating electrostatic force is applied to the first roller 72 and is supplied from a fifth voltage source S5. The rollers 78, 80, 82, and 84 are transfer backup rollers used to transfer an image on each of the first through fourth photosensitive bodies 40, 42, 44, and 46 to the transfer belt 70. Since the image on the first through fourth photosensitive bodies 40, 42, 44, and 46 is charged, in order to transfer the image to the transfer belt 70, each of the rollers 78, 80, 82, and 84 needs to be oppositely charged from to the charging state of the image. To this end, voltage sources S1, S2, S3, and S4 are applied to each of the rollers 78, 80, 82, and 84.

The roller 74 is a driver roller and drives the transfer belt 70 so that a developed image formed on each of the photosensitive bodies 40, 42, 44, and 46 is precisely superimposed in a given position of the transfer belt 70 and a color image formed after superimposing is precisely transferred from the transfer belt 70 onto the sheet of paper 90.

However, in the conventional wet color image forming apparatus, the color image formed on the transfer belt 70 is transferred onto the sheet of paper 90 by a pressure between the roller 76 and the transfer belt 70 and electrostatic force caused by the voltage applied to the roller 72.

Unfortunately, in conventional wet color image forming devices, deep corrugation formed on the surface of sheets of paper, such as Xerox 4024 or Gilbert paper, cause a degredation in image transfer quality. A color image is not transferred to the corrugation portions of the sheet of paper, leaving a void phenomenon, which further causes a local ink flow. This phenomenon causes the image quality to suffer.

### SUMMARY OF THE INVENTION

The present invention provides a wet color image forming apparatus to transfer an image from a transfer belt onto a sheet of paper regardless of the surface roughness of the sheet of paper, and a method of forming an image using the same.

According to an aspect of the present invention, there is provided a wet color image forming apparatus, the apparatus comprising a photosensitive body on which an electrostatic latent image corresponding to image information input from an outside source is formed. The apparatus further comprises a developing unit, which supplies a developing agent to the electrostatic latent image formed on the photosensitive body and develops an image. The apparatus comprises a transfer belt, which is supported by a plurality of rollers and is rotatably installed, to which the image developed by the developing unit is superimposed and transferred. A color image is formed on the surface of the transfer belt. The image is formed of a plurality of layers and reduces a hardness of a surface layer of the plurality of layers. The color image, thus formed, contacts a sheet of paper by removing carbon from a material constituting the surface layer. The apparatus further comprises a transfer roller installed opposite to one of the plurality of rollers where the transfer belt is placed between the transfer roller and the plurality of rollers. The transfer roller applies pressure to the transfer belt to transfer the color image formed on the transfer belt onto the sheet of paper.

According to another aspect of the present invention, there is provided a method of forming an image using a wet color image forming apparatus. The apparatus preferably comprises a photosensitive body on which an electrostatic latent image corresponding image information input from the outside is formed, a developing unit, which supplies a developing agent to the electrostatic latent image formed on the photosensitive body and develops an image, a transfer belt to which the image developed by the developing unit is superimposed and transferred, a color image being formed on the surface of the transfer belt, and a transfer roller, which applies pressure to the transfer belt to transfer the color image formed on the transfer belt on to the sheet of paper. When the image is transferred from the transfer belt onto a sheet of paper, the transfer roller is formed of a plurality of layers. By removing carbon from a material constituting the surface layer of the plurality layers contacting a sheet of paper, the surface layer is formed so as to reduce a hardness of the transfer belt, and the transfer roller applies force greater than or equal to 70 kg (10 kg/cm²) with respect to the whole area contacting the transfer belt.

### BRIEF DESCRIPTION OF THE DRAWING FIGURES

The above and other aspects and advantages of the present invention will become more apparent by describing in detail preferred embodiments thereof with reference to the attached drawing figures, in which:

FIG. 1 shows an example of a conventional wet color image forming apparatus;

FIG. 2 schematically shows a structure of a wet color image forming apparatus according to an embodiment of the present invention;

FIG. 3 shows an operation of transferring a color image from a transfer belt shown in FIG. 2 onto a sheet of paper;

FIG. 4 is an expended cross-sectional view of a part of the transfer belt shown in FIG. 2;

FIG. 5 is a graph of a transfer efficiency of the transfer belt in a case where a surface layer is composed of carbon (C) according to an embodiment of the present invention; and

FIG. 6 is a graph of hardness versus transfer efficiency of the transfer belt according to an embodiment of the present invention.

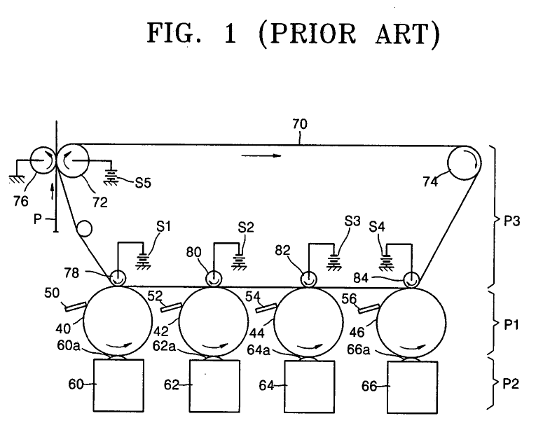

Throughout the drawing figures it should be understood that like reference numbers refer to like features and structures.

### DETAILED DESCRIPTION OF THE PREFERRED EMBODIMENTS

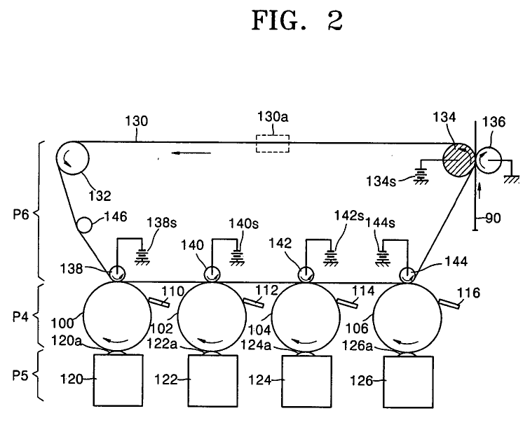

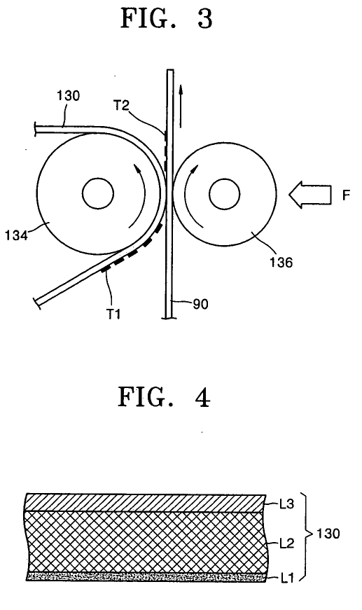

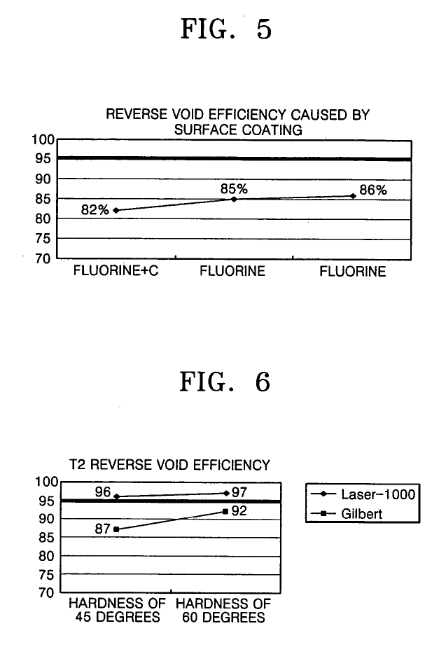

FIG. 2 schematically shows a structure of a wet color image forming apparatus according to an embodiment of the present invention. FIG. 3 shows an operation of transferring a color image from a transfer belt shown in FIG. 2 onto a sheet of paper. FIG. 4 is an expanded cross-sectional view of a part of the transfer belt shown in FIG. 2. FIG. 5 is a graph of a transfer efficiency of the transfer belt in a case where a surface layer is composed of carbon (C) according to an embodiment of the present invention. FIG. 6 is a graph of hardness versus transfer efficiency of the transfer belt according to an embodiment of the present invention.

Referring to FIG. 2, the wet color image forming apparatus according to an embodiment of the present invention includes a photosensitive body portion P4 on which electrostatic latent images are formed according to the color configuration of image information input from an outside source; a developing unit portion P5, which develops the electrostatic latent images as a desired color; and a transfer portion P6, which transfers a superimposed and developed color image from the photosensitive body portion P4 onto a sheet of paper 90.

The photosensitive body portion P4 includes a plurality of photosensitive bodies 100, 102, 104, and 106 which are rotatably installed and on which electrostatic latent images are formed, and a plurality of cleaning blades 110, 112, 114, and 116, which are adjacent to the plurality of photosensitive bodies 100, 102, 104, and 106 and clean a developing agent smeared on the surface of the plurality of photosensitive bodies 100, 102, 104, and 106.

The first through fourth photosensitive bodies 100, 102, 104, and 106 are photosensitive drums, such as a photosensitive drum on which an electrostatic latent image corresponding to individual color components of an image is formed. As an exaple, the photosensitive bodies 100, 102, 104 and 106 may correspond to cyan, magenta, yellow and black components of an image. An eraser for neutralizing a charging state of each of the first through fourth photosensitive bodies 100, 102, 104, and 106, a charger for charging the surface of the neutralized photosensitive body before the electrostatic latent image is formed, and a light scanning unit (LSU) for forming an electrostatic latent image by radiating light on the surface of the charged photosensitive body are further provided around the first through fourth photosensitive bodies 100, 102, 104, and 106. For clarity, these well known elements are not shown.

The developing unit portion P5 is placed below the photosensitive body portion P3 to correspond to the first through fourth photosensitive bodies 100, 102, 104, and 106. The developing unit portion P5 includes first through fourth developing units 120, 122, 124, and 126 for storing color developing agents, such as cyan ink, magenta ink, yellow ink, and black ink needed in developing the electrostatic latent images formed on the first through fourth photosensitive bodies 100, 102, 104, and 106. The developing unit portion P5 also includes first through fourth developing rollers 120a, 122a, 124a, and 126a, which are installed on the first through fourth developing units 120, 122, 124, and 126 to be in contact with the first through fourth photosensitive bodies 100, 102, 104, and 106. The first through fourth developing rollers 120a, 122a, 124a, and 126a supply the color developing agents stored in the first through fourth developing units 120, 122, 124, and 126 to the first through fourth photosensitive bodies 100, 102, 104, and 106.

The transfer portion P6 includes a transfer belt 130, which is supported by a plurality of rollers 132, 134, 138, 140, 142, and 144. The transfer belt 130 is rotatably installed in contact with the first through fourth photosensitive bodies 100, 102, 104, and 106. The color developing agents are transferred from the first through fourth photosensitive bodies 100, 102, 104, and 106 to the transfer belt 130. A desired color image is formed on the transfer belt 130, and a transfer roller 136, which is installed at one side of the transfer belt 130 to be in contact with the transfer belt 130 applies pressure to the transfer belt 130 to transfer the color image formed on the surface of the transfer belt 130 onto the sheet of paper 90.

The plurality of rollers 132, 134, 138, 140, 142, and 144 include a driving roller 132 for providing driving force used to rotate the transfer belt 130, a transfer backup roller 134, which is installed opposite to the transfer roller 136 where the transfer belt 130 is placed between the transfer roller 136 and the transfer backup roller 134. The transfer backup roller 134 supports pressure applied from the transfer roller 136 and transfers the color image formed on the surface of the transfer belt 130 onto the sheet of paper 90. A plurality of backup rollers 138, 140, 142, and 144, are installed opposite to each of the first through fourth photosensitive bodies 100, 102, 104, and 106 with the transfer belt 130 placed between each of the first through fourth photosensitive bodies 100, 102, 104, and 106 and each of the backup rollers 138, 140, 142, and 144. The backup rollers 138, 140, 142, and 144 transfer each color developing agent from the first through fourth photosensitive bodies 100, 102, 104, and 106 to the transfer belt 130. The transfer roller 136 is grounded, and the transfer backup roller 134 and each of the backup rollers 138, 140, 142, and 144 are connected to voltage sources 134s, 138s, 140s, 142s, ad 144s so that voltages are supplied thereto. This is because transfer of each color developing agent from the first through fourth photosensitive bodies 100, 102, 104, and 106 to the transfer belt 130 and transfer of the color image from the transfer belt 130 onto the sheet of paper 90 uses a voltage difference between the transfer backup roller 134 and each of the backup rollers 138, 140, 142, and 144.

Referring to FIG. 3, a color image Ti formed on the transfer belt 130 is transferred from the transfer belt 130 onto the sheet of paper 90 by force F applied from the transfer roller 136 and the transfer backup roller 134 for supporting the force F and is fused on the sheet of paper 90, thereby forming a color image T2.

In this case, when the sheet of paper 90 is a rough paper having a deep corrugation, the color image T1 formed on the transfer belt 130 is not efficiently transferred to the corrugation of the sheet of paper 90 such that a void phenomenon occurs where the color image T1 is not transferred to some portions of the color image T2 fused on the sheet of paper 90.

A method of measuring the void phenomenon and a transfer efficiency is shown in Table 1.

TABLE 1

| Classification | Reverse void efficiency | | Transfer efficiency of transfer belt |
|---|---|---|---|
| Purpose | Media flexibility evaluation | | Transfer performance evaluation |
| Evaluation method | 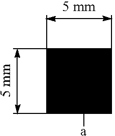 | 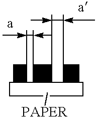 | 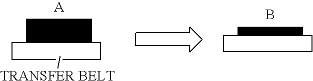 |

| | | |
|---|---|---|
| Evaluation basis | Reverse void efficiency = measured | Transfer efficiency of transfer belt = |
| | area/25 cm² | (A-B)/(A) |
| Measuring device | Image X-pert | OD meter |

Here, A is the whole optical density (OD) of a transfer belt nip, B is OD remaining on the transfer belt, and OD is the degree of darkness in which an image on a sheet of paper is measured using an optical density (OD) meter.

Referring to Table 1, the reverse void efficiency is the ratio of a space in which the color image is not transferred from the transfer belt 130. In other words, the reverse void efficiency is the ratio betweenthe area in which a remaining color image except for the whole are a of a or a′ is transferred, to the area 25 cm² of a rectangular form having width and length of 5 mm, respectively.

The transfer efficiency of the transfer belt is the ratio in which the amount of the color image formed on the surface of the transfer belt 130 is divided by the amount of the color image transferred onto the sheet of paper 90.

Thus, there is only a difference in a measuring viewpoint between the reverse void efficiency and the transfer efficiency, and the two measurements produce substantially the same result. In other words, a high reverse void efficiency indicates that a small void occurs on the color image transferred onto the sheet of paper 90 and a transfer efficiency is high. The reverse void efficiency is an efficiency in which the void does not occur and transfer is performed, and thus, refers to a transfer efficiency.

In order to prevent the void phenomenon and improve the transfer efficiency, the color image formed on the transfer belt 130 needs to be transferred to the corrugation of the sheet of paper 90.

To this end, first, a method of reducing the depth of the corrugation formed on the sheet of paper 90 may be considered. Since the sheet of paper 90 is compressed by strong force in a manufacturing process, even though stronger force is applied to the sheet of paper 90, there are limitations in reducing the depth of the corrugation.

Thus, by flattening the surface of the transfer belt 130 so that an ink layer formed on the surface of the transfer belt 130 reaches the corrugation of the sheet of paper 90, or by increasing pressure applied to the transfer belt 130 using the transfer roller 136, the void phenomenon can be prevented, and the transfer efficiency can be improved.

First, in order to flatten the surface of the transfer belt 130, the physical and chemical properties of the transfer belt 130 should be changed.

Referring to FIG. 4, the transfer belt 130 is formed of three layers L1, L2, and L3. A first layer L1 (hereinafter, referred to as a surface layer) is a layer contacting the transfer belt 130, a third layer L3 is a layer contacting the driving roller 132, the transfer backup roller 134 and the plurality of backup rollers 138, 140, 142, and 144, and a second layer L2 is an elastic layer interposed between the surface layer L1 and the third layer L3. The second layer L2 is thicker than the surface layer L1 and the third layer L3. Of course, the transfer belt 130 may be formed of three or more layers, as occasion demands.

By making the thickness of the transfer belt smaller and reducing the temperature thereof, the surface of the transfer belt 130 can be flattened. Thus, preferably, the thickness of the surface layer L1 of the transfer belt 130 is less than or equal to 5 μm, and by removing car bon (C) from a material constituting the transfer belt 130, the transfer belt 130 has a Shore hardness (Shore A) less than 60 degrees. In particular, the thickness of the surface layer L1 of the transfer belt 130 is preferably between 2 and 3 μm inclusive, and the transfer belt 130 prefer ably has a Shore hardness (Shore A) greater than or equal to 45 degrees and less than or equal to 60 degrees.

The higher the content of carbon (C) in the surface layer L1, the higher the hardness. Thus, by removing carbon (C) from the material constituting the transfer belt 130, a desired hardness can be obtained.

Referring to FIG. 5, when carbon (C) is contained in a material constituting the surface layer L1, a reverse void efficiency, that is, a transfer efficiency is 82%. However, when carbon (C) is removed from the material constituting the surface layer L1, a transfer efficiency is between 85 and 86% inclusive.

In other words, when carbon (C) is not contained in the material constituting the surface layer L1, the occurrence rate of a void is reduced to 3-4%, compared to a void occurring when carbon (C) is contained in the material constituting the surface layer L1.

Next, a method of increasing pressure applied to the transfer belt 130 using the transfer roller 136 will be described. When pressure applied to the transfer belt 130 is increased by the transfer roller 136, if a hardness of the transfer roller 136 is low, the transfer roller 136 is transformed, and the contact area between the sheet of paper 90 and the transfer belt 130 is reduced. Thus, the hardness of the transfer roller 136 needs to be increased.

Force greater than or equal to 70 kg (10 kg/cm²) with respect to the whole area contacting the transfer belt 130 is applied to the transfer belt 130 using the transfer roller 136. In this case, a harness of the transfer roller 136 is Shore A greater than 60 degrees, preferably, Shore A 65±5 degrees.

Referring to FIG. 6, in the prior art, a transfer efficiency of a paper (Gilbert) having a rough surface, measured using a hardness (Shore A 45 degrees) of the transfer roller 136, is 87%, and the transfer efficiency of a paper (Laser-1000) having a soft surface is 96%. How ever, when the hardness of the transfer roller 136 is Shore A 60 degrees and pressure of the transfer roller 136 is 70 kg according to the present invention, the transfer efficiency of the paper (for example, Gilbert) having a rough surface is 92%, and the transfer efficiency of the paper (for example, Laser-1000) having a soft surface is 97%. In other words, the transfer efficiency of the rough paper is increased by more than 5%.

An operation of forming an image and transferring the image onto a sheet of paper using the wet color image forming apparatus having the above structure, according to an embodiment of the present invention will be described with reference to the attached drawings.

Referring to FIGS. 2 and 3, a laser scanning unit (not shown) forms electrostatic latent images on the photosensitive bodies 100, 102, 104, and 106 according to image information transmitted from an outside source. The electrostatic latent images are developed by color developing agents transmitted from the developing rollers 120a, 122a, 124a, and 126a as four colors (cyan, magenta, black, and yellow), respectively.

The four-color developed color images are superimposed and transferred to the transfer belt 130, and a color image T1 corresponding to the image information transmitted from the outside source is formed.

The color image T1 formed on the transfer belt 130 passes a contact surface between the transfer roller 136 and the transfer backup roller 134, is transferred onto the sheet of paper 90, and is fused on the sheet of paper 90, such that a desired image is obtained.

As described above, in the wet color image forming apparatus according to an embodiment of the present invention, on both a paper having a soft surface and a paper having a rough surface, by reducing the amount voids, a transfer efficiency of an image from a transfer belt onto a sheet of paper is increased, and an image quality is improved. In addition, the amount of ink exhaustion is reduced such that the life span of the transfer belt is advantageously lengthened.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A wet color image forming apparatus comprising:
a photosensitive body on which an electrostatic latent image corresponding to image information is formed;
a developing unit, which supplies a developing agent to the electrostatic latent image formed on the photosensitive body and develops an image;
a transfer belt supported by a plurality of rollers, rotatably installed, and to which the image developed by the developing unit is superimposed and transferred such that a color image is formed on the surface of the transfer belt, said transfer belt being formed of a plurality of layers contacting a sheet of paper, said plurality of layers comprising a surface layer made of a material having carbon removed to reduce a harness of the surface layer; and
a transfer roller, which is installed opposite to one of the plurality of rollers such that the transfer belt is placed between the transfer roller and said one of the plurality of rollers, and applies pressure to the transfer belt to transfer the color image formed on the transfer belt on to the sheet of paper.

2. The apparatus of claim 1, wherein the hardness of the surface layer of the transfer belt is less than Shore A 60 degrees.

3. The apparatus of claim 2, wherein the hardness of the surface layer of the transfer belt is greater than or equal to Shore A 45 degrees and less than or equal to Shore A 60 degrees.

4. The apparatus of claim 2, wherein the thickness of the surface layer of the transfer belt is less than or equal to 5 μm.

5. The apparatus of claim 1, wherein the thickness of the surface layer of the transfer belt is less than or equal to 5 μm.

6. The apparatus of claim 1, wherein the hardness of the transfer roller is greater than or equal to Shore A 60 degrees.

7. The apparatus of claim 6, wherein the transfer roller applies force greater than or equal to 70 kg (10 kg/cm²) with respect to the area contacting the transfer belt.

8. A method of forming an image using a wet color image forming apparatus comprising a photosensitive body on which an electrostatic latent image corresponding to image information is formed, a developing unit, which supplies a developing agent to the electrostatic latent image formed on the photosensitive body and develops an image, a transfer belt to which the image developed by the developing unit is superimposed and transferred, a color image being formed on the surface of the transfer belt, and a transfer roller, which applies pressure to the transfer belt to transfer the color image formed on the transfer belt onto the sheet of paper, comprising the steps of:
forming the transfer belt of a plurality of layers comprising a surface layer adapted to contact a sheet of paper;
removing carbon from a material constituting the surface layer so as to reduce a hardness of the transfer belt;
and applying a force greater than or equal to 70 kg (10 kg/cm²) with respect to the area contacting the transfer belt with the transfer roller.

9. The method of claim 8, wherein the hardness of the surface layer of the transfer belt is less than Shore A 60 degrees.

10. The method of claim 9, wherein the hardness of the surface layer of the transfer belt is greater than or equal to Shore A 45 degrees and less than or equal to Shore A 60 degrees.

11. The method of claim 9, wherein the thickness of the surface layer of the transfer belt is less than or equal to 5 μm.

12. The method of claim 8, wherein the thickness of the surface layer of the transfer belt is less than or equal to 5 μm.

13. The method of claim 9, wherein the hardness of the transfer roller is greater than or equal to Shore A 70 degrees.
